(19) United States
(12) Patent Application Publication
(10) Pub. No.: US 2021/0324308 A1
(43) Pub. Date: Oct. 21, 2021

(54) METHOD FOR ISOMERIZING HOPS AND MATCHING THE FLAVOR PROFILE OF BOILED HOPS

(71) Applicant: BREWJACKET, INC., Boulder, CO (US)

(72) Inventors: Aaron Walls, Boulder, CO (US); Matthew Goff, Broomfield, CO (US); Evgeniy Tkachenko, Broomfield, CO (US); Chris Collins, Boulder, CO (US)

(73) Assignee: BREWJACKET, INC., Boulder, CO (US)

(21) Appl. No.: 17/272,467

(22) PCT Filed: Aug. 29, 2019
(86) PCT No.: PCT/US19/48829

§ 371 Date: Mar. 1, 2021

Related U.S. Application Data
(60) Provisional application No. 62/725,022, filed on Aug. 30, 2018.

(51) Int. Cl. C12C 3/12; C12C 3/02

(52) U.S. Cl. CPC C12C 3/12; C12C 3/02

(57) ABSTRACT

A method of processing hops independently of the brewing process to produce hops that can be added to a brew to achieve a particular flavor and bitterness profile without the need for boiling after addition of the hops. A batch of hops is saturated in a liquid and adjusted to a predetermined pH. The pH adjusted batch is then heated to a predetermined temperature under a predetermined amount of pressure for a predetermined period of time to replicate the particular flavor and bitterness profile of conventionally boiled hops and wort. The processed hops may then be added during the brewing process to accurately and repeatedly reproduce a particular flavor and bitterness profile without having to undergo a boil.

### BACKGROUND OF THE INVENTION

### 1. FIELD OF THE INVENTION

The present invention relates to the processing of hops during the making of beer and, more specifically, to a method for more consistently controlling the isomerization and oil profile of hops.

### 2. DESCRIPTION OF THE RELATED ART

During the process of making beer, hops are added to boiling sugar water created from grains (called wort) to create certain flavors and add bitterness to the wort. When hops are heated, a percentage of the oils in the hops volatize, depending on the temperature the hops are exposed to and the duration that they are exposed to that temperature. The percentage of hop oil that is volatized affects the aromatic profile and flavor profile for a specific beer. In addition to hop oil volatilization, heating hops in wort causes the hops acids to undergo a process called isomerization where the alpha acids in hops are converted into iso-alpha acids, which provides the characteristic bitter taste.

To produce the maximum amount of bitterness, the hops must be boiled for a long time period, which often greater than 60 minutes (dependent on altitude, wort pH, and other factors). Wort boiling is an energy intensive, difficult, and time-consuming process. Additionally, boiling the wort with the hops changes the flavor profile of the wort due to sugar caramelization, protein and tannin coagulation, and other processes. All of these variables together make creating consistent beers very difficult for both amateurs and professionals alike.

A conventional approach to addressing the problem of hop preparation and addition is to perform pre-isomerization to convert the alpha acids into iso-acids before the hops are added to the beer. Pre-isomerization of hops attempts to solve the hop addition problem by allowing the brewer to achieve hop bitterness without having to bring the entire beer preparation to boiling temperature for a long period of time. However, pre-isomerized hops do not provide the same flavor profile as hops that have been traditionally boiled. As a result, it is virtually impossible to create a beer solely with pre-isomerized hops that is an exact substitute for a beer created with non-isomerized hops that have been boiled according to a standard beer recipe.

After a beer has been brewed, the final product is evaluated to ensure that it matches the flavor profile that the brewer intended. If the hop profile is incorrect due to either brewer error or due to crop variation, it is not possible to correct that individual beer. Isomerized hop extract may be used to add bitterness, but it cannot provide the appropriate oil profile to exactly impact flavor and aromatics. Brewers will often blend the trouble beer with other batches to adjust the flavor profile, but this approach requires one or more additional batches to be created with offsetting characteristics. As a result, adjustment of a final product is a challenging, time consuming, and expensive endeavor that can disrupt brew schedules.

In an effort to solve the problem of how to process hops to achieve the bitterness profile in each brew, sonic hop processors will use a metal catalyzed process to isomerize the alphas acids in hops and produce hop pellets that can be added in the beer brewing process to impart bitterness without extended boil times. These pellets often have difficult dissolving, require vigorous stirring, and lack the volatized oils necessary to fully match the flavor profile of boiled hops. Other efforts to solve the problem include the extraction of the oils directly from hops, such as by super critical CO₂ extraction, for later addition of the extracted oils to the brewing process. While the extracted oils can be used to adjust bitterness, they cannot match the flavor profile of boiled hops.

Accordingly, there is a need in the art for an approach that can more consistently match both the flavor and bitterness profile of hops that have been boiled for a pre-determined amount of time without the need for boiling at any stage of brewing process.

### BRIEF SUMMARY OF THE INVENTION

The present invention is a method of processing hops independently of the brewing process to produce hops that can be added to a brew to achieve a particular flavor and bitterness profile without the need for boiling after addition of the hops. More specifically, the present invention comprises the steps of obtaining a batch of hops, saturating the batch of hops in a liquid that has been adjusted to a predetermined pH, and heating the batch of hops to a predetermined temperature under a predetermined amount of pressure for a predetermined period of time. The step of saturating the batch of hops in a liquid may comprise saturating the batch of hops in water. The predetermined pH may be between 4.8 and 5.6. The predetermined temperature may be about 212° F. (100° C.). The predetermined pressure may be atmospheric pressure. The predetermined time period corresponds to an amount of time that a corresponding brew with untreated hops would be boiled. For example, the predetermined time period may be 5 minutes, 30 minutes, 60 minutes, or 120 minutes. The method may also include the step of adding the batch of hops to an amount of wort to further achieve a particular flavor and bitterness profile without the need for any boiling after the batch of hops is added to the amount of wort. The method may also include the step of drying the batch of hops after the predetermined time period so that the dried hops can be used at a later date.

### BRIEF DESCRIPTION OF THE SEVERAL VIEWS OF THE DRAWINGS

The present invention will be more fully understood and appreciated by reading the following Detailed Description in conjunction with the accompanying drawings, which:

FIG. 1 is a flow chart of the method for processing hops according to the present invention.

### DETAILED DESCRIPTION OF THE INVENTION

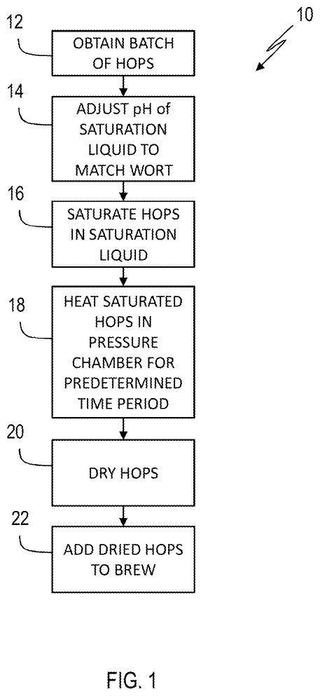

Referring to the figures, wherein like numeral refer to like parts throughout, there is seen in FIG. 1, a method 10 for processing hops that can replicate the flavor and bitterness profile of hops that have been boiled for pre-determined periods of time. For example, method 10 can be used to match the flavor and bitterness profile of hops from low temperature bitterness additions such as whirlpool/hop-stands, to high temperature boil hop additions such as 5 minutes, 30 minutes, 60 minutes, 120 minutes, etc. Method 10 begins with a batch of hops in any conventional state 12 such as whole cone, pulverized, powdered, lupin gland separated, etc. A saturation liquid, such as water, is then pH adjusted 14 to be in the same pH range as wort (approx. 4.8 to 5.6). Other liquids, such as wort, can also be used. The hops are then saturated in the pH adjusted liquid 16. The saturated hops are then placed in a steam chamber and held at temperatures at or above traditional water boiling temperatures under atmospheric pressure (212° F. or 100° C.) for a predetermined period of time 18 to produce a particular flavor profile, such as one that matches the desired flavor profile for a particular brew. It should be recognized that the period of time, particular temperate, pressure, and type of heat source may be adjusted to account for the particular equipment being used, the local altitude, the local humidity, the particular hop crop, and other variable factors that can impact the resulting flavor profile. While optimal results Dave been achieved using steam as the heat source but other heat sources may be used. For example, other approaches for heating the hops can be used such as boiling, steaming, microwave, radiation, and heat exchange piping. The processed hops may then be dried 20 for future use. For example, a brewer can add the dried hops to a brew 22 at any stage in the brewing process to add the desired bitterness and flavor profile.

The chamber may comprise a traditional stovetop steamer basket, a combi-steam oven, a SWECO® mixer with a modified input for both dry and wet heat, or a brewing mash tun with a false bottom that allows for steam to be piped into the bottom liquid capture port via a portable steam generator. In mass production settings, a typical continuous steamer can be used, which is simply a metal wire belt passing that an insulated chamber with steam being applied usually below, but also from the top.

As an example, a steam chamber may be preheated at atmospheric pressure to its maximum, i.e., water boiling temperature (212° F. or 100° C.) at sea level. Preheating is important for controlling the amount of time the hops spend at the elevated temperature and thus matching a desired profile. Once the steam chamber is preheated, hops are added and steamed for an amount of time corresponding to the intended profile. For example, a 60 minute boil hop profile can be matched with precision by holding the saturated hops at or above a water boiling temperature (212° F. or 100° C.) for approximately 60 minutes, depending on the particular equipment and other variable factors identified above. After 60 minutes, the hops are removed from the steamer and placed in a drying chamber. To match a 15 minute boil hop profile, the saturated hops may be held at the water boiling temperature for 15 minutes, subject to variables such as the particular equipment and other factors such as elevation that may impact the precise temperatures. To match the profile of whirlpool hop brew (which typically involves processing the wort and hops at between 7.55° F. to 185° F. for about 10 to 30 minutes), the saturated hops of method 10 are added to a preheated steam chamber in a vacuum and held at 155° F. to 185° F. for a corresponding amount of time as the particular whirlpool hop profile to be matched. While it is possible to process the hops in an oven set to a temperature between 155° and 185° at atmospheric pressure, the use of a steam chamber produces the highest quality results as dry heat can produce excessive browning of the vegetal matter and change the flavor of the hops.

Method 10 may include the step of packing the dried hops for future use, distribution, storage, or sale to a third party. In addition, hops processed according to the present invention can be tested for degree of isomerization of the alpha acids and the presence of volatile oils using standard laboratory equipment and methods to verify the amount of isomerized acids present as well as the amount of volatile hop oils that are present. In this manner, a particular amount of isomerized acids and volatile hop oils can be consistently produced and used to match the flavor and bitterness profile of hops that have been boiled for a pre-determined amount of time without the need for boiling of the brew at any stage of brewing process.

What is claimed is:

1. A method of processing hops, comprising the steps of:
obtaining a batch of hops;
adjusting a saturation liquid to a predetermined pH;
saturating the batch of hops in the saturation liquid; and
heating the batch of hops to a predetermined temperature under a predetermined amount of pressure for a predetermined period of time.

2. The method of claim 1, wherein the step of saturating the batch of hops in a liquid comprises saturating the batch of hops in water.

3. The method of claim 1, wherein the predetermined pH is between 4.8 and 5.6.

4. The method of claim 1, wherein the predetermined temperature is about 212° F. (100° C.).

5. The method of claim 1, wherein the predetermined amount of pressure is atmospheric pressure.

6. The method of claim 1, wherein the predetermined period of time corresponds to an amount of time that a corresponding brew with untreated hops would be boiled.

7. The method of claim 6, wherein the predetermined period of time is selected from the group consisting of 5 minutes, 30 minutes, 60 minutes, and 120 minutes.

8. The method of claim 1, further comprising the step of adding the batch of hops to an amount of wort.

9. The method of claim 8, wherein the batch of hops and the amount of wort are not boiled after the step of adding the batch of hops to the amount of wort.

10. The method of claim 1, further comprising the step of drying the batch of hops after the predetermined time period.

11. The method of claim 1, wherein the step of heating the batch of hops comprises heating the batch of hops in a steam chamber.

12. A beer made with hops processed according to claim 1.
